(19) United States
(12) Patent Application Publication
(10) Pub. No.: US 2026/0206678 A1
(43) Pub. Date: Jul. 23, 2026

(54) Method for Dispensing Spreading Material Using an Agricultural Spreader

(71) Applicant: Amazonen-Werke H. Dreyer SE & Co. KG, Hasbergen (DE)

(72) Inventor: Thomas WESSELS, Osnabrück (DE)

(73) Assignee: Amazonen-Werke H. Dreyer SE & Co. KG, Hasbergen (DE)

(21) Appl. No.: 19/141,556

(22) PCT Filed: Dec. 18, 2023
(86) PCT No.: PCT/EP2023/086233

§ 371 Date: Jun. 20, 2025

(30) Foreign Application Priority Data
Dec. 20, 2022 (DE) 10 2022 133 991.2

(51) Int. Cl. A01C 17/00

(52) U.S. Cl. CPC A01C 17/008; A01C 17/001

(57) ABSTRACT

A method for dispensing spreading material with an agricultural spreader, which comprises at least one spreading element for generating a spread fan and at least one spread-fan sensor for monitoring the distribution of the spreading material within the spread fan, wherein the spread-fan sensor is at least partially heated by a heating means to ensure an operation of the sensor independent of contamination and/or deposits.

### CROSS REFERENCE TO RELATED APPLICATIONS

The present application claims priority under 35 U.S.C. § 365 to PCT/EP 2023/086233 filed on Dec. 18, 2023 and under 35 U.S.C. § 119(a) to German Application No. 10 2022 133 991.2 filed on Dec. 20, 2022, both of which are incorporate by reference in their entireties.

### TECHNICAL FIELD

The present disclosure relates to a method for dispensing spreading material with an agricultural spreader, which comprises at least one spreading element for generating a spread fan and at least one spread-fan sensor for monitoring the spreading material distribution within the spread fan. Further objects of the disclosure are an agricultural spreader and a spread-fan sensor.

### BACKGROUND

In agricultural applications, a wide variety of different types of spreading material are often applied to utilizable areas, such as fields or pastures. This can be grainy, granular or powdery spreading material, in particular fertilizer or lime, which is spread on the utilizable areas to influence plant growth, for example.

Spreaders are generally used for dispensing the spreading material, with which an even and at the same time large-area distribution of the spreading material can be achieved. For this purpose, such spreaders generally comprise two spreading elements, which are often configured in the form of rotatably mounted spreading discs. The spreading material to be spread is usually directed onto the rotating spreading elements and distributed over a wide area by these using centrifugal forces. As a rule, a spread fan directed to the rear is formed on each spreading element, via which the spreading material is applied to the utilizable area.

To distribute the spreading material over the entire utilizable area, the spreaders are usually moved over the utilizable area along parallel paths that are spaced apart from each other according to the width of the spread fans generated, for which purpose such spreaders can either be attached or mounted on agricultural tractors or alternatively be configured to be self-propelled.

The local spreading material distribution within the spread fans, in particular the so-called lateral distribution of the spreading material transverse to the direction of travel of the spreader, depends on numerous influencing factors, such as wind influences, the homogeneity of the spreading material, the state of wear of the spreading elements, a possible slope of the utilizable area or also acceleration and braking processes of the tractor.

To avoid irregularities in the spreading material distribution, modern spreaders generally comprise several spread-fan sensors, which can be used to monitor the spreading material distribution and in particular the lateral distribution in the spread fans.

EP 2 777 376 B1, for example, discloses a spreader on which several non-contact spread-fan sensors based on radar technology are arranged. Each individual spread-fan sensor monitors a sector-like section of the entire spread fan. If disturbances and/or deviations in the spreading material distribution are detected, parameters of the spreader can be adjusted via a control unit in order to improve the overall spreading material distribution in the spread fan via changes in the spreading material distribution in the sector-like sections. These parameters can be, for example, the rotation speed or rotational speed of the spreading elements or the feed, in particular the feeding point, of the spreading material to the spreading elements.

Such spreaders with spread-fan sensors enable a more even distribution of the spreading material on the utilizable area and have proven themselves in agricultural practice. However, when using such spreaders in the field under unfavorable spreading conditions, the problem arises that the sensor surfaces of the spread-fan sensors become dirty and thus output incorrect measured values of the spreading material or lateral distribution or even become completely unusable. In addition to particles whirled up by the utilizable area or present in the ambient air, an important source of soiling is often the spreading material itself, whose components and dust can settle on the spread-fan sensors. Contamination from precipitation or dew on the sensor surfaces can also interfere with the reliable detection of spreading material distribution. The sensor surfaces of the spread-fan sensors must therefore be cleaned regularly in the field. For cleaning the sensor surfaces, DE 10 2014 106 777 A1 proposes a cleaning unit arranged on the spreader, which comprises a brush, a wiper or a nozzle for removing the deposits.

Such spreaders with cleaning units for the spread-fan sensors have also proven themselves in principle. However, under unfavorable spreading conditions, the cleaning units themselves can become soiled in such spreaders, which can limit their functionality. For example, heavy soiling deposits can block the structurally complex mechanics of the wiper or brush and clog the nozzle, which can only be removed by time-consuming manual cleaning. Furthermore, under very unfavorable spreading conditions, such heavy soiling can occur that the cleaning units can no longer reliably remove it.

### SUMMARY

Against this background, an object of the disclosure is to provide a method for dispensing spreading material in which the spreading material spreading can be reliably detected without the need for time-consuming cleaning of the sensor surfaces of the spread-fan sensors or the cleaning units.

This object can be solved in a method of the type mentioned herein.

The spread-fan sensor is at least partially heated with a heating means to ensure an operation of the sensor independent of contamination and/or deposits. This allows the spread-fan sensor, which may be wet with water due to precipitation or dew, to be dried by evaporation of the water deposits. Less soiling or other deposits can adhere to a dry spread-fan sensor. Furthermore, the dirt or deposits can be dried. Dry soiling or deposits hinder the spread fan detection less than moist soiling or deposits. Heating and the resulting drying of the spread-fan sensor can ensure that the spreading material distribution is reliably detected. The operational readiness of the spread-fan sensor can thus be increased without having to clean it at regular intervals.

With regard to the configuration of the heating means, it is proposed that the spread-fan sensor is heated with the heating means over a heating period at a heating temperature during the distribution of spreading material to dry a sensor surface. By heating the spread-fan sensor over a heating period with a heating temperature, soiling due to moisture occurring on the spread-fan sensor, in particular on its sensor surface, can be dried during spreading material application. Such contamination due to moisture or wetness can result, for example, from dew formation, precipitation or swirling water droplets. The sensor surface of the spread-fan sensor can be kept free in an advantageous way by heating during the distribution of spreading material. Furthermore, drying the sensor surface can prove to be advantageous with regard to spread-fan sensors that operate using radar technology, as radar radiation or radar waves can be absorbed by moisture. Heating a spread-fan sensor that emits radar waves to dry the sensor surface can increase its operational readiness and functionality.

In this context, it is further proposed that the spread-fan sensor is heated with the heating means over a preheating period at a preheating temperature to dry the sensor surface before the spreader is operated. This ensures that the spread-fan sensor is ready for use at the start of the distribution of spreading material. In particular, moisture or wetness resulting from precipitation or dew formation outside the spreading operation can be dried in an advantageous way before the spreading operation or the distribution of spreading material. Preheating the spread-fan sensor over a preheating period with a preheating temperature can thus advantageously ensure reliable sensor operation at the start of the distribution of spreading material. In this context, it has proven to be advantageous if the spread-fan sensor is heated automatically, in particular time-controlled, over a preheating period with a preheating temperature in such a way that the spread-fan sensor is dried at the start of the distribution of spreading material. For example, preheating can take place in the morning a certain amount of time before the start of the working day.

In an advantageous configuration, it is proposed that the preheating temperature is greater than the heating temperature. This enables the spread-fan sensor to dry quickly during the pre-heating period. In particular, heavy moisture contamination, which can for example result from increased dew formation at night, can be dried quickly and reliably before the distribution of spreading material begins.

It is also proposed that the heating temperature and/or the preheating temperature be adjusted at intervals. This enables adapted heating, in particular the heating temperature and/or the preheating temperature can be adapted to the prevailing ambient conditions. For example, if the ambient temperature is low, the heating temperature and/or the preheating temperature can be increased to effectively dry the spread-fan sensor. If the ambient temperature rises, as is usually the case during the course of the day, the heating temperature can be reduced. Furthermore, the heating temperature and/or the preheating temperature can be adapted to the degree of moisture formation on the spread-fan sensor. This ensures reliable drying of the spread-fan sensor even under different ambient conditions. Furthermore, such a configuration allows energy-efficient heating of the spread-fan sensor, as the heating temperature and/or the preheating temperature can be reduced, for example, when there is less moisture formation, which can save energy. The energy required to dry and keep the spread-fan sensor free can be varied by adjusting the heating temperature and preheating temperature at intervals.

It has proven to be particularly advantageous if the spread-fan sensor is heated with the heating means in such a way that a sensor temperature is always above a dew point temperature. Such a configuration makes it possible to always reliably avoid contamination due to moisture or wetness on the spread-fan sensor due to dew formation. The sensor temperature to be used as a reference for this can either be a value set manually or automatically by the operating personnel or can be set via a temperature sensor arranged on the spread-fan sensor.

It is also proposed that the dew point temperature is determined from one or more environmental parameters. This ensures that the current dew point temperature at the point of distribution of spreading material is always used. This allows the sensor temperature to be adjusted as accurately as possible to the respective value of the dew point temperature. Determining the dew point temperature as accurately as possible allows the use of energy for heating to be improved.

It has been found to be advantageous if the environmental parameters are recorded by an environmental sensor arranged in particular on the spreader and/or originate from an external data source. Such an environmental sensor arranged on the spreader enables particularly accurate detection of the current environmental conditions at the respective location of the distribution of spreading material. Alternatively, however, the environmental sensor can also be arranged on the tractor or fixed, for example at the edge of the utilizable area or centrally between several utilizable areas. In particular, the environmental sensor can be configured as a weather station. Databases or internet-based data sources for environmental parameters, for example, can serve as an external data source for the environmental parameters. Alternatively or additionally, historical data of the environmental parameters can also be used.

In this context, it is proposed that the environmental parameters comprise weather parameters and/or position parameters. Such a configuration advantageously enables a particularly accurate and reliable consideration of the weather during the distribution of spreading material and/or the location of the respective utilizable area.

It is further proposed that the weather parameters comprise temperature parameters and/or humidity parameters and/or air pressure parameters. These parameters can be used to determine the dew point temperature particularly accurately. Furthermore, other weather parameters can also be determined or recorded, which can be used to determine or estimate the dew point temperature. For example, wind parameters can also be taken into account, which can be used to determine the risk of dust formation or turbulence of the spreading material.

With regard to the position parameters, it is proposed that these comprise location parameters and/or time parameters. The location parameters may comprise, in particular, location information such as GPS data and/or altitude data of the respective usable area. In addition to information on the time of day, the time parameters may also comprise information on the season and/or the position of the sun. Furthermore, information on the usable area, such as the soil condition, in particular its moisture content and thus the risk of dust formation, may also be included.

It has also proven advantageous if the sensor temperature is determined on the basis of one or more environmental parameters. In particular, a target sensor temperature can be specified on the basis of one or more environmental parameters. It has proven advantageous if the sensor temperature is determined as a function of the temperature parameters. In an alternative configuration, the sensor temperature can be determined using a temperature sensor installed in the spread-fan sensor. Alternatively, the respective air temperature or another suitable temperature value can be used as a reference value for the sensor temperature.

With regard to the structural configuration of the heating means, it has proven advantageous if the heating means is configured as an electric heating means. This enables structurally simple and easily controllable heating of the spread-fan sensor, which enables effective drying of the spread-fan sensor. In an advantageous configuration, the heating means can be operatively connected to the electrical system of the agricultural tractor for power supply. Alternatively, a separate power supply can be provided.

With regard to the positioning of the heating means, it is proposed that the heating means be arranged outside the sensor surface of the spread-fan sensor. In this way, it can be avoided that the heating means impairs or obscures the field of view of the sensor. In particular, the heating means can be arranged at least partially on the outside of the periphery of the field of view of the spread-fan sensor. This enables effective and efficient heat transfer to the sensor surface of the spread-fan sensor to be dried. In this context, it has been found particularly advantageous, with regard to heating the spread-fan sensor as uniformly as possible, if the heating means is arranged at least partially on the outside around the sensor surface.

From a structural perspective, it has proven advantageous if the heating means is arranged on a housing of the spread-fan sensor. Such a configuration allows particularly rapid heating of the spread-fan sensor in the immediate vicinity of the location of the contamination. In particular, the heating means can be positioned as close as possible to the sensor surface by the arrangement on a housing of the spread-fan sensor. From a structural point of view, it may be advantageous in this context if the heating means is arranged as an insert in the housing of the spread-fan sensor. This also allows the heating means to be easily replaced in the event of a defect. In a further advantageous embodiment, the heating means can be arranged in the immediate vicinity of the spread-fan sensor, in particular on a circuit board of the spread-fan sensor. This allows the environment of the spread-fan sensor to be heated.

With regard to the structural configuration of the heating means, it is also proposed that this be configured as a heating wire arranged at least partially around the sensor surface. This enables particularly uniform heating of the spread-fan sensor and, in particular, of the sensor surface. Depending on the application, the heating wire can be arranged on the housing in a spiral, zigzag or meandering pattern, for example. The configuration of the heating wire can be easily adapted to the requirements of the sensor heating and/or to the available installation space. In an alternative configuration, the heating means can also be configured as a heating means integrated into the sensor surface—for example, as a thin heating wire that does not interfere with sensor operation, similar to a vehicle window heater. Alternatively or in addition to an electric heating wire, inductive heating means or infrared heating means are also conceivable, which can be used to evaporate and/or vaporize moisture located on the spread-fan sensor. Furthermore, to prevent contamination, the sensor surface may be coated at least partially with a moisture-or dirt-repellent material.

In a further advantageous configuration, it is proposed that the spread-fan sensor be supplied with compressed air at least partially for cleaning the sensor surface. The supply of compressed air can enable both additional drying of the sensor surface and removal of deposits or contamination.

In this context, it has proven advantageous if the spread-fan sensor is supplied with compressed air via the compressed air supply for a ventilation period during the distribution of spreading material in order to clean the sensor surface. The compressed air supply during a ventilation period can be used, on the one hand, to dry any moisture contamination occurring on the spread-fan sensor, in particular on its sensor surface, during the distribution of spreading material and, on the other hand, to remove any deposits already adhering by the compressed air.

It is also proposed that several spread fan sensors are provided, which are heated separately, at least in part, by the heating means and/or are supplied with compressed air, at least in part, by the compressed air supply. Several spread fan sensors advantageously allow more com-prehensive detection of the spreading pattern in the spread fan, in particular of the transverse distribution of the spreading material in the spread fan. Separate heating and/or compressed air supply ensures that each individual spread-fan sensor operates independently of contamination and/or deposits.

In this context, it has proven advantageous to heat the spread-fan sensors for different lengths of time and/or at different temperatures. In particular, the heating times and/or heating temperatures can be adapted to the degree of contamination or moisture wetting of the spreader fan sensors. In the event of heavy contamination, a comparatively long heating time and/or an increased heating temperature can be selected. In the event of low contamination, lower heating temperatures and/or shorter heating times can be selected.

In this context, it is further proposed that the spread-fan sensors are heated for different heating times and/or preheating times and/or with different heating temperatures and/or preheating temperatures depending on their position relative to the spreading element and/or to the spread fan. This configuration makes it possible to heat and/or preheat each spread-fan sensor individually depending on its exposure to contamination. In particular, spread-fan sensors, which are exposed to a greater risk of contamination or wetting by moisture during spreading operation, can be heated at higher heating temperatures and/or for longer heating times in order to dry them. In addition, spread fan sensors, which, due to their position relative to the spreading element and/or to the spread fan, are exposed to less contamination, can be heated for shorter heating periods and/or at lower heating temperatures. This ensures reliable sensor operation for all spread-fan sensors, regardless of their position relative to the spreading element and/or the spread fan.

Under particularly unfavorable spreading conditions, deposits may form on the spread-fan sensor, in particular on its sensor surface, despite the heating means. These deposits may result in particular from the adhesion of particles of the spreading material, air dust or soil particles. In order to enable reliable detection of the spreading material distribution in the spread fan, it is proposed that the spread fan sensor be at least partially subjected to a vibration exciter to ensure sensor operation independent of contamination and/or deposits. The vibration excitation can reduce or remove contamination and/or deposits on the spread fan sensors. In particular, stubborn encrustations on the spread-fan sensor can be broken up and removed quickly and reliably. The vibration and the resulting cleaning of the spread-fan sensor ensure that the spread material distribution is detected reliably. Alternatively or additionally, the vibration exciter can be configured to apply vibrations to the spread-fan sensor in such a way that contamination and/or deposits are prevented and/or reduced from the outset or during spreading operation. Furthermore, it may be provided that the spread-fan sensor is subjected to the vibration exciter before the start of spreading operation and/or at certain, in particular adjustable, intervals and/or time spans during spreading operation. The operational readiness of the spread-fan sensor can thus be increased without it having to be cleaned manually at regular intervals.

In an advantageous further development of the disclosure, it is proposed that the spreader fan sensor is excited for cleaning a sensor surface with the vibration exciter at an excitation frequency different from the natural frequency of the spreader for an excitation duration. This configuration allows particularly fast and thorough cleaning of the sensor surface. In particular, an excitation frequency different from the natural frequency of the spreader increases the effective-ness of the vibration excitation and thus the cleaning or descaling of the spread-fan sensor. It is particularly advantageous if the excitation frequency and/or the excitation duration can be adjusted, for example to adapt to the degree of contamination of the spread-fan sensor.

In this context, it is proposed that the spread-fan sensor be excited with several excitation frequencies, at least one of which corresponds to a natural frequency of the spread-fan sensor or a part of the spread-fan sensor. This allows particularly thorough cleaning of the sensor surface. The excitation frequencies can also be advantageously adapted to the type and/or degree of contamination.

From a control engineering perspective, it has been found advantageous to interrupt the monitoring of the spread material distribution with the spread sensor during the excitation duration. This ensures that the monitoring of the spread material distribution in the spread fan is not disturbed or distorted by the vibration excitation. In this context, it is particularly advantageous if the excitation duration is kept as short as possible in order to allow the shortest possible interruption of the monitoring of the spread material distribution.

It is also proposed that the excitation frequency be selected and set so that the monitoring of the distribution of the scattered material is not disturbed. In particular, the excitation frequency or its spectrum can be selected and set so that it is filtered out by an evaluation electronics of the spread-fan sensor in such a way that it is not used for monitoring or evaluating the distribution of the scattered material. This has the advantage that the vibration does not interfere with, hinder or distort the detection of the spread material distribution in the spread fan.

In this context, it has been found advantageous if the spread-fan sensor is at least partially subjected to a vibration exciter during an interruption of the distribution of spreading material. This ensures that the vibration is applied when no spreading material is being distributed and therefore no spreading material distribution needs to be detected. Such an interruption of the distribution of spreading material can take place, for example, during the turning process. Furthermore, an interruption of the distribution of spreading material can also take place for one of the spreading elements, for example at the edge of the usable area. A spread-fan sensor assigned to this spreading element can be applied in an advantageous manner during the interruption of the distribution of spreading material.

In this context, it has proven advantageous if the evaluation electronics of the spread-fan sensor is adapted to the excitation frequency. In particular, it can be advantageous if the evaluation electronics temporarily filters out the corresponding interference signals during the vibration excitation. This can improve the quality of the detection of the transverse distribution of the spreading material.

From a structural point of view, it is advantageous if several spread-fan sensors are provided, which are subjected to vibration separately, each with one vibration exciter, or in groups, each with one vibration exciter, at least partially, in order to clean the sensor surfaces. Such a configuration enables the respective spread-fan sensors to be cleaned in a suitable manner. In particular, the individual spread-fan sensors can then be excited with a vibration when they comprise a critical degree of contamination. The separate control of the vibration exciters of the individual spread fan sensors also has the advantage that a brief interruption in the detection of the spread material distribution associated with the vibration excitation is limited to only one spread fan sensor. In this case, the corresponding spread fan sensor can be excluded from the detection of the spread material distribution of the spread fan. Alternatively, several spread-fan sensors can be actuated simultaneously with the respective vibration exciter, whereby a brief, simultaneous interruption in the detection of the spread material distribution via these spread-fan sensors may occur, but this is accompanied by simplified control.

In this context, it is proposed that the spread-fan sensors be excited for different excitation durations. This allows further adjustment of the vibration application to the conditions of the respective spread-fan sensor, in particular its degree of contamination or deposits, to be achieved in an advantageous manner. The degree of contamination can be detected by sensors or specified as a predetermined value.

It is proposed that the spread fan sensors are excited for different excitation durations depending on their position relative to the spreading element and/or to the spread fan. This makes it possible to react to the different environmental influences acting on the spread fan sensors arranged at different positions. Since the dust and/or dirt load can vary considerably depending on the position of the respective spread fan sensors relative to the spreading element and/or the spread fan, such a configuration enables the spread fan sensors to be activated as required. Furthermore, the energy required for descaling can be reduced by adjusting the excitation duration to the respective contamination situation.

To solve the above-mentioned object, an agricultural spreader for dispensing spreading material, with at least one spreading element for generating a spread fan and at least one spread-fan sensor for monitoring the distribution of the spreading material within the spread fan, which comprises heating means for at least partially heating the spread-fan sensor to ensure an operation of the sensor independent of contamination and/or deposits. This spreader offers the advantages explained above in connection with the method for dispensing spreading material. Such a configuration allows, in particular, an increase in the operational readiness of the spreader, since possible moisture and/or dirt deposits on the spreader fan sensor can be dried by the heating means. Contamination or deposits adhere less easily to a dry spreader fan sensor, which means that the corresponding spreader fan sensor needs to be cleaned less frequently.

In an advantageous configuration, the at least one spread fan sensor is arranged below or above the spreading element, its field of view being aligned at an angle relative to a longitudinal axis of the spreader. Such a configuration of the spread fan sensor enables particularly accurate and reliable detection of the distribution of the spreading material in the spread fan, in particular the transverse distribution of the spreading material.

It is further proposed that the agricultural spreader comprises several spread fan sensors, each comprising a heating means, wherein the spread fan sensors are aligned at different detection angles relative to the longitudinal axis of the spreader in order to detect different fields of view. Such a configuration allows the spread fan to be detected over as large an area as possible in order to detect the spreading material or transverse distribution in the spread fan as accurately as possible.

In this context, it is also proposed that the heating means of the individual spread-fan sensors can be controlled separately. This makes it possible, in particular, for the heating means of the individual spread-fan sensors to be switched on or off independently of one another. This ensures that the individual spread-fan sensors are heated in accordance with requirements. For example, those spread-fan sensors that are exposed to greater contamination can be subjected to longer heating times and/or higher heating temperatures. Spread-fan sensors located in less exposed areas can be heated for shorter periods and/or at lower temperatures. This enables the individual spread-fan sensors to be heated in an adapted manner, which also ensures efficient use of energy for drying. In an alternative configuration, the heating means can only be controlled together or in groups. This results in reduced control effort.

In a particularly preferred embodiment, the heating means of the individual spread-fan sensors can be controlled separately to set different heating times and/or heating temperatures and/or preheating times and/or preheating temperatures. Such a configuration allows the heating times and/or heating temperatures and/or preheating times and/or preheating temperatures to be precisely adapted to the conditions and installation situations of the respective spread-fan sensors.

In an advantageous further development of the disclosure, it is proposed that the spreader comprises two spreading elements arranged symmetrically to a longitudinal axis of the spreader, to each of which are assigned several spread-fan sensors arranged symmetrically to the longitudinal axis. Such a configuration enables uniform dispensing of the spreading material on both sides of the longitudinal axis and reliable monitoring of the spreading material distribution in the two parts of the spread fan configured to the left and right of the longitudinal axis of the spreader. Furthermore, such a configuration enables comparatively simple control of the heating means. The heating means of the spread fan sensors of the left and right spreading elements can thus also be controlled symmetrically with respect to the longitudinal axis.

An agricultural spreader for dispensing spreading material is also proposed, which comprises at least one spreading element for generating a spread fan and at least one spread fan sensor for monitoring the distribution of the spreading material within the spread fan, wherein a vibration exciter is provided for at least partially actuating the spread-fan sensor to ensure that the sensor operates independently of contamination and/or deposits. This results in the advantages already explained in connection with the method for dispensing spreading material.

It has been found advantageous to provide several spreader sensors, each comprising at least one vibration exciter, wherein the spreader sensors are aligned at different detection angles relative to the longitudinal axis of the spreader in order to detect different fields of view. Such a configuration enables large-area, finer resolution and, even in the event of individual spread-fan sensors failing, reliable detection of the spread material distribution. Furthermore, the finer resolution detection of the spread material distribution enables more precise adjustment of the spread material distribution.

It is proposed that the vibration exciters of the individual spread-fan sensors can be controlled separately. This ensures that the individual spreader sensors can be independently activated for cleaning with a vibration exciter in the event of contamination or deposits. Alternatively, the vibration exciters of the individual spreader sensors can be controlled together, which is simpler in terms of control technology.

An advantageous configuration provides that the vibration exciters can be controlled separately to set different excitation durations and/or excitation frequencies. This allows more precise adaptation to the respective contamination situation at the spread-fan sensors.

In addition, to solve the above-mentioned object, a spread-fan sensor is proposed for monitoring the distribution of spreading material in a spread fan generated by a spreader for distributing spreading material on a usable area, which comprises heating means for at least partially heating the spread-fan sensor to ensure an operation of the sensor independent of contamination and/or deposits. Such a spread-fan sensor also offers the advantages mentioned above in relation to the method for dispensing spreading material and the agricultural spreader.

Furthermore, a spread-fan sensor is proposed for monitoring the distribution of spreading material in a spread fan generated by a spreader for distributing spreading material on a usable area, which comprises a vibration exciter for at least partially exciting the spread-fan sensor to ensure that the sensor operates independently of contamination and/or deposits. This results in the advantages explained in connection with the method for dispensing spreading material and the agricultural spreader.

### BRIEF DESCRIPTION OF THE DRAWINGS

Further details and advantages of the disclosure are explained below with the aid of the accompanying drawings according to FIGS. 1 to 6b. These show:

FIG. 1 shows a perspective view of an agricultural spreader attached to a tractor;

FIG. 2 shows an enlarged detailed view of a section of the illustration according to FIG. 1; FIGS. 3-4 show two enlarged detailed views of a section of the illustration according to FIG. 2;

FIG. 5a shows a partially sectioned top view of an agricultural spreader attached to a tractor according to the illustration in FIG. 1;

FIG. 5b shows an enlarged partial view of a section of the illustration according to FIG. 5a;

FIG. 6a shows a schematic, exemplary curve of the heating temperatures over time;

FIG. 6b shows a schematic representation of an example of the curve of the dew point temperature and the sensor temperature based on the curve of the heating temperatures according to FIG. 6a, and

FIGS. 7-8 show two further enlarged detailed views of a section of the illustration according to FIG. 2.

### DETAILED DESCRIPTION

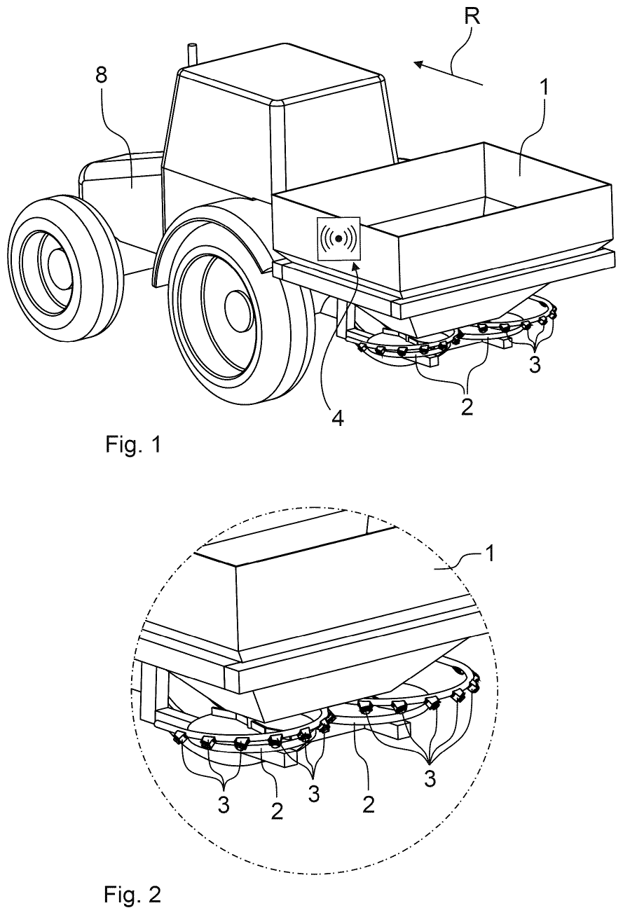

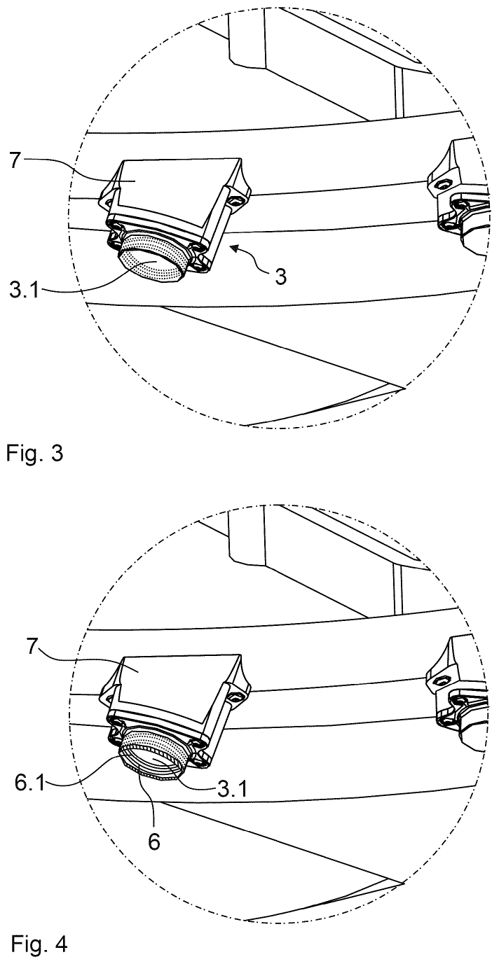

The illustration in FIG. 1 shows a perspective top view of an agricultural spreader 1 for dispensing spreading material on an agricultural usable area, for example a grain field or a pasture. The spreader 1 can be used to spread various types of spreading material on the usable area, in particular powdered or granular fertilizer and lime. The spreader 1 is mounted on an agricultural tractor 8, but can alternatively be attached to the tractor 8 or be self-propelled.

The spreader 1 comprises two spreading elements 2 for spreading the spreading material over the usable area. The spreading elements 2 are configured as plate-shaped spreading discs arranged next to each other on one level, which rotate in opposite directions to distribute the spreading material. The spreading material is fed via a feed line and/or metering device from a storage container arranged above the spreading elements 2 from above onto the rotating spreading elements 2, in particular to a respective feeding point on the spreading elements 2. Due to the rotation speed or rotational speed of the spreading elements 2, the spreading material is thrown out behind the spreader 1 in a direction opposite to the direction of travel R by centrifugal forces.

The area behind and partly next to the spreader 1, in which the spreading material is distributed over the usable area, is referred to as the spread fan F. The spread fan F generally comprises essentially a circular sector, with each spreading element 2 spreading only in a partial area of the spread fan F. However, there is generally a transition area between the partial areas in which spreading material is distributed by both spreading elements 2. The width of the spread fan F transverse to the direction of travel R, which generally significantly exceeds the width of the spreader 1, can be adjusted via various parameters of the spreader 1. These include, for example, the rotational speed of the spreading elements 2, the point of impact of the spreading material on the spreading elements 2 or the properties of the spreading material.

In order to ensure that the plants growing on the usable area are supplied with spreading material in a uniform manner, it is generally desirable to distribute the spreading material as evenly as possible within the spread fan F. The distribution of the spreading material within the spread fan F is referred to as spreading material distribution or also as transverse distribution. In order to be able to detect and/or evaluate the distribution of the spreading material, the spreader 1 comprises several spread-fan sensors 3, see FIG. 1.

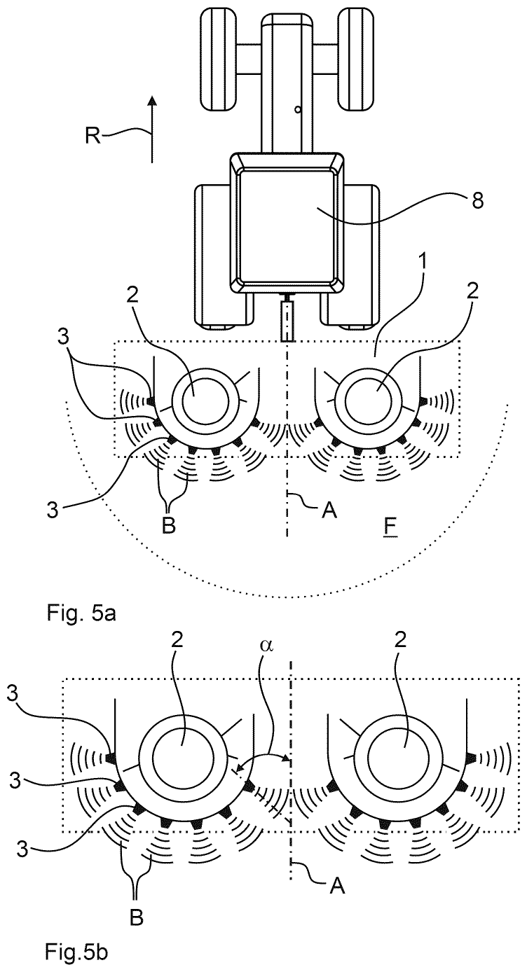

The spread-fan sensors 3 are configured as radar sensors and are arranged above the spreading elements 2, whereby they are positioned comparatively close to the spreading elements 2 for reliable detection of the spreading material distribution. Alternatively, the spread-fan sensors 3 may also have a different operating principle and/or be arranged below the spreading elements 2 and/or on the storage container. Each spread fan sensor 3 monitors a different segment or sector-like section of the spread fan F, which is why the individual spread fan sensors 3 are arranged in a semicircular pattern around the respective spreading element 2, see also FIG. 5a. The viewing ranges B of the spread fan sensors 3 are directed radially outwards. The individual spread fan sensors 3 are aligned at different detection angles α relative to the longitudinal axis A of the spreader 1 in order to cover or detect the entire spread fan F. The two spreading elements 2 of the spreader 1 are arranged symmetrically on both sides of the longitudinal axis A, see FIG. 5a. The spread-fan sensors 3 assigned to the spreading elements 2 are also arranged symmetrically on both sides of the longitudinal axis A. However, other, for example asymmetrical, configurations of the spreading elements 2 and/or the spread-fan sensors 3 are also conceivable if this should be found advantageous in the respective application.

The spread-fan sensors 3 each comprise a sensor surface 3.1, see FIG. 3, via which a sensor signal, in this case the radar signal, is transmitted and received again for detecting the distribution of the spread material in the spread fan F. For correct and reliable detection of the distribution of the spreading material, it is necessary that the sensor surface 3.1 is as free as possible from contamination and deposits. For example, water droplets, i.e. deposits from precipitation, fog or dew, can interfere with the radar signal. The sensor signal is evaluated by an evaluation electronics unit.

Particularly with damp spread-fan sensors 3, there is a problem that fine-grained, powdery or dusty contaminants adhere to them and/or can develop into encrustations. This is particularly problematic if the sensor surface 3.1 becomes contaminated, as this can interfere with the detection of the spread material distribution. The contamination can result, for example, from the spreading material itself, which is often at least partially pulverized when it hits the spreading elements 2 and when it is distributed or dispensed via the spreading elements 2, and is released into the ambient air as dust. From there, it can accumulate on the spread-fan sensors 3. Furthermore, particles already present in the ambient air or stirred up from the floor of the usable area can adhere to the spread-fan sensors 3 as deposits, especially if their surfaces are damp.

To ensure that the sensor operates independently of contamination and/or deposits, the spread-fan sensor 3 is therefore at least partially heated by a heating means 6. This allows the spread-fan sensor 3 to be dried by evaporation or vaporization of the water deposits. Less contamination or other deposits can adhere to a dry spread-fan sensor 3, which at least reduces or even eliminates the need for cleaning and thus increases its operational readiness.

The function and configuration of the heating means 6 are explained below with reference to the illustrations in FIGS. 3 and 4. The heating means 6 is configured as an electric heating means which can be supplied with electric current via the on-board electrical system of the tractor 8. Alternatively, the heating means 6 can be supplied with power via a separate power supply. As shown in FIG. 4, the heating means is configured as a heating wire 6.1, which is arranged on a housing 7 of the spread-fan sensor 3. The heating wire 6.1 is arranged outside the sensor surface 3.1 of the spread-fan sensor 3. The heating wire 6.1 is wound in a spiral around the sensor surface 3.1 of the spread-fan sensor 3. Alternatively, the heating wire 6.1 can also be arranged only in sections around the sensor surface 3.1 or laid in a different pattern. Depending on the application, the heating wire 6.1 may be laid in a meandering, bifilar, modular, or other pattern. Furthermore, the heating wire 6.1 can alternatively or additionally be integrated into the sensor surface 3.1, for which purpose it must be configured relatively thin so as not to interfere with or impede detection of the transverse distribution of the spreading material S. Furthermore, the heating wire 6.1 can also be arranged on the inside of the housing 7 of the spread-fan sensor 3.

In addition, with regard to simple and quick replaceability of the heating means 6, it may be advantageous if this is configured as an insert or replacement element connected to the spread-fan sensor 3 in a detachable manner.

When the heating means 6 configured as a heating wire 6.1 is supplied with electrical current, it emits heat and thereby heats the spread-fan sensor 3. The configuration of the heating wire 6.1 ensures that mainly the sensor surface 3.1 of the spread-fan sensor 3 is heated. As a result of the heating, the water adhering to the spread-fan sensor 3 and in particular to the sensor surface 3.1 evaporates. The spread-fan sensor 3 or the sensor surface 3.1 are dried. The drying can be controlled via the heating temperature TH and the heating duration DH, whereby different heating temperatures TH and heating durations DH can be set depending on the ambient conditions.

Alternatively or in addition to a configuration as a heating wire 6.1 operating on the basis of resistance heating, the heating means 6 can also be configured in other ways, for example as an inductive heating element or as a heating means 6 operating on the basis of infrared radiation or microwave radiation.

In order to ensure that the spread-fan sensor 3 is ready for operation immediately at the start of distribution of spreading material, for example at the start of work in the early morning, it is provided that the spread-fan sensor 3 can also be heated to a preheating temperature T_{V} over a preheating period D_{V}. Preheating allows water that forms on the spread-fan sensor 3 during an interruption in operation, for example during a nighttime rest period, to be removed. Especially at night, condensation often forms on the spread-fan sensors 3, which can be removed by preheating. Preferably, the heating means 6 is configured in the manner of a parking heater so that automated preheating takes place in such a way that the spread-fan sensor 3 is at least partially dried at the start of spreading material.

Since the most relevant source of moisture deposits on the spread-fan sensor 3 is dew formation, even during distribution of spreading material during the day, the spread-fan sensor 3 is heated by the heating means 6 to ensure that the sensor operates independently of contamination and/or deposits, such that that a sensor temperature T_{S} is always above the dew point temperature T_{T} during spreading operation. This ensures that the moisture present in the air cannot condense on the spreader fan sensor 3 and deposit as water deposits on the sensor surface 3.1, for example.

As a prerequisite for such a procedure, the sensor temperature T_{S} must be determined or established. The value of the sensor temperature Ts corresponds to a setpoint or specified value which, as explained, should be above the current dew point temperature T_{T}. To determine the sensor temperature T_{S}, either a temperature sensor can be provided on the spreader 1 or on the spreader fan sensor 3, or the sensor temperature T_{S} can be determined using one or more environmental parameters. For this purpose, the sensor temperature T_{S} can be determined, for example, on the basis of the current temperature of the ambient air or can be determined or specified on the basis of any other variables.

The dew point temperature T_{T} can also be determined from one or more environmental parameters. In particular, one or more environmental sensors 4 can be arranged on the spreader 1 to detect the environmental parameters. Alternatively or additionally, environmental sensors 4 may be provided on the tractor 8 and/or arranged away from the spreader 1, for example at the edge of the usable area. It is also conceivable that the environmental parameters are retrieved from an external data source. This may be a database or an Internet-based data source.

The environmental parameters comprise weather parameters and position parameters, wherein the weather parameters comprise in particular those parameters which can be used to determine the dew point temperature T_{T}. These may be in particular temperature parameters and/or humidity parameters and/or air pressure parameters. Further weather parameters are also conceivable.

The position parameters comprise location parameters and time parameters. The location parameters can be determined using a satellite system for position determination, such as GPS. Furthermore, the location parameters can also comprise information on the height above sea level and/or on the properties of the soil of the usable area, in particular with regard to its moisture content, and/or on the plants grown on the usable area. Other location parameters influencing the formation of moisture and/or contamination on the spread-fan sensor 3 are also conceivable here. In addition to the time of day, the time parameters may also include information about the position of the sun or the season. Furthermore, other parameters are also conceivable which can be used to determine or estimate the dew point temperature T_{T} and/or the sensor temperature T_{S}.

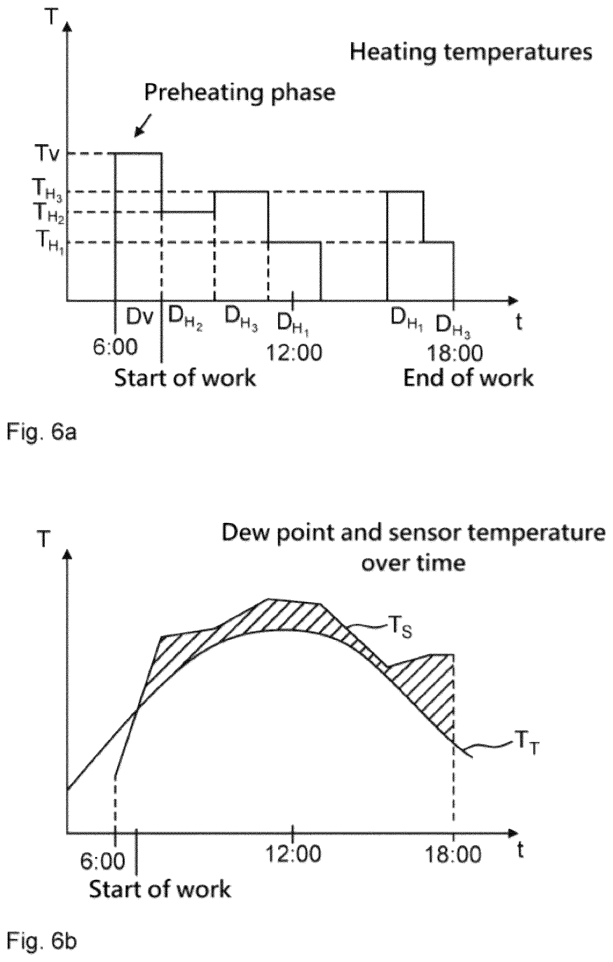

The following explanations, based on the illustrations in FIG. 6a and FIG. 6b, describe how an exemplary spread-fan sensor 3.1 is heated with the heating means 6 before and during the distribution of spreading material. The schematic diagram in FIG. 6a shows an exemplary sequence of heating intervals I over a working day, which begins at 8:00 a.m. To ensure that the spread-fan sensor 3 is dry at the start of work after nighttime dew formation or other wetting with moisture, the preheating phase begins at 6:00 a.m. In this preheating phase, the heating means 6 is set to a preheating temperature T_{V}, which is maintained over the preheating duration D_{V}. As can be seen from the diagram in FIG. 6b, which has the same time scale as the diagram in FIG. 6a, the sensor temperature T_{S} at the start of the preheating period D_{V} is at a comparatively low level due to the nighttime cooling. Since the sensor temperature T_{S} is also below the dew point temperature T_{T}, dew formation on the spread-fan sensor 3 is to be expected. As a result of heating with the heating means 6 from 6:00 a.m., the sensor temperature T_{S} rises and exceeds the dew point temperature T_{T}, so that the spread-fan sensor 3 dries. The hatched area in FIG. 6b symbolizes the drying of the spread-fan sensor 3, since in this case the sensor temperature T_{S} is above the dew point temperature T_{T}.

At the start of work at 8:00 a.m., which marks the start of distribution of spreading material with spreader 1, the sensor temperature T_{S} is significantly above the dew point temperature T_{T} as a result of preheating. In order to enable comparatively energy-efficient heating, the heating temperature T_{H} is then set to a mean value T_{H2}, which is below the preheating temperature T_{V}, and maintained for the heating period D_{H2}, see FIG. 6a. Due to the lower heating temperature D_{H2}, the sensor temperature T_{S} approaches the dew point temperature T_{T}, which initially rises during the course of the day. To prevent the sensor temperature T_{S} from falling below the dew point temperature T_{T}, the heating temperature is set to the value T_{H3} for a heating period D_{H3}, whereby the heating temperature T_{H3} is higher than the heating temperature T_{H2}. This causes the sensor temperature T_{S} to rise again and the difference to the dew point temperature T_{T} increases during the heating period D_{H3}.

Heating can then be provided for a heating period D_{H1} with a lower heating temperature T_{H1}, as there is no risk of the sensor temperature T_{S} falling below the dew point temperature T_{T}. As the day progresses, especially at midday when high ambient temperatures are recorded due to high solar radiation, the heating of the spread-fan sensor 3 can even be switched off. The spread-fan sensor 3 is only heated again in the late afternoon, initially for a heating period D_{H3} with the heating temperature T_{H3} and then for a heating period D_{H1} with the heating temperature T_{H1}.

The above example of heating a spread-fan sensor 3 during the course of the day clearly shows how different heating times D_{H} and preheating times D_{V} as well as heating temperatures T_{H} and preheating temperatures T_{V} can be used to control the sensor temperature T_{S} in such a way that the sensor temperature T_{S} always remains above the dew point temperature T_{T} during the distribution of spreading material. This ensures that no dew can form on the spreader fan sensor 3. Since the spreader fan sensor 3 remains dry or is dried in this respect, particles of the spreading material and other contaminants cannot adhere to the spreader fan sensor 3 and/or form incrustations, or can only do so to a limited extent. In this way, trouble-free sensor operation for detecting the transverse distribution of the spreading material in the spread fan F can be ensured. Furthermore, the cleaning effort required to clean the spread fan sensor 3 and, in particular, the sensor surface 3.1 is considerably reduced.

The temperature curves explained above according to FIGS. 6a and 6b are to be understood as examples. In particular, the heating temperature curve shown in FIG. 6a can be adjusted as desired, both with regard to the heating and preheating temperatures T_{H}, T_{V} and the heating and preheating durations D_{H}, D_{V}. Furthermore, the number and length of the heating intervals I can also be adjusted as desired to suit the respective application. In addition, temperature values other than the sensor temperature T_{S} and the dew point temperature T_{T} can also be used as reference or comparison values.

The following explanation, based on the illustrations in FIG. 5 a and b, shows how the heating means 6 of the individual spread-fan sensors 3, which monitor different sections or sectors of the spread fan F, can be controlled separately. Depending on the position of the spread-fan sensors 3 relative to the spreading elements 2 or to the longitudinal axis A, these are exposed to a greater or lesser risk of frost formation and the accumulation of water and moisture. For example, spreader sensors 3 positioned close to the longitudinal axis A may be somewhat more protected by elements of the spreader 1 than spreader sensors 3 arranged in outer areas of the spreader 1. On the other hand, the individual spreader sensors 3 may be exposed to different loads or exposures to dust or contamination particles. For this reason, the heating means 6 of the various spread-fan sensors 3 can be controlled separately, whereby their heating can be adapted to the respective installation situation. Spread-fan sensors 3 which are arranged in particularly exposed positions can, for example, be heated via longer heating times D_{H} or preheating times D_{V} or with higher heating temperatures T_{H} or preheating temperatures T_{V} than spread-fan sensors 3 which are not exposed to any significant contamination by water or dust particles. Alternatively, however, it may also be advantageous to heat all spread-fan sensors 3 simultaneously or synchronously in order to simplify control. It is also conceivable to provide only some of the spread-fan sensors 3 with heating means 6.

The spread-fan sensors 3 can also be supplied with compressed air for cleaning the sensor surfaces 3.1 using compressed air supply not shown in the figures. In this case, each spread-fan sensor 3 can be assigned a compressed air supply. Alternatively, only some of the spread-fan sensors 3 can be assigned a compressed air supply. The compressed air supply can be directed to the respective sensor surface 3.1, in particular for cleaning and/or drying. In a manner analogous to the intermittent heating by means of the heating means 6, the spread-fan sensors 3 can be supplied with compressed air for different ventilation durations. Furthermore, different pressure levels of the compressed air can also be set. The ventilation durations and/or the pressure levels of the compressed air can be adjusted at intervals. In particular, the ventilation durations and/or the pressure levels of the compressed air can be adjusted to the respective contamination and/or deposits.

The spread-fan sensors 3 and, in particular, their sensor surfaces 3.1 can also be provided with a water-and/or dirt-repellent coating, which can reduce the adhesion of moisture and/or dirt.

Particularly in the case of damp spread-fan sensors 3, there is the problem that fine-grained, powdery or dust-like contaminants adhere to them and can develop into stubborn encrustations. This is particularly problematic if the sensor surface 3.1 becomes encrusted, as this can interfere with the detection of the spread material distribution. The contamination in the form of encrustations can result, for example, from the spreading material itself, which is often at least partially pulverized when it hits the spreading elements 2 and when it is distributed or dispensed via the spreading elements 2, and is released into the ambient air as dust. From there, it can accumulate on the spread-fan sensors 3. Furthermore, particles already present in the ambient air or stirred up from the floor of the usable area can adhere to the spread-fan sensors 3 as deposits.

To ensure that the sensor operates independently of contamination and/or deposits, the spread-fan sensor 3 is therefore at least partially excited by a vibration exciter 9. This prevents, reduces, breaks up and/or removes contamination, in particular encrustations, on the spread-fan sensor 3. The need for manual cleaning can be reduced and the operational readiness of the spread-fan sensor 3 can be increased.

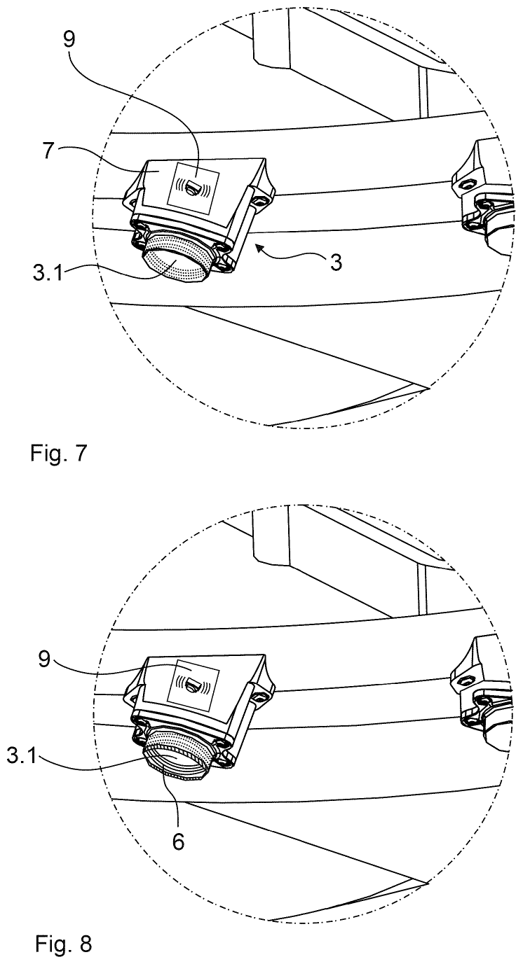

The function and configuration of the vibration exciter 9 are explained below with reference to the illustrations in FIGS. 7 and 8. The vibration exciter 9 is arranged on a housing 7 of the spread fan sensor 3 so that the sensor surface 3.1 of the spread fan sensor 3 can be excited to vibrate at least partially or in sections. The spread fan sensor 3 is connected to the on-board electrical system of the tractor 8 to supply it with electrical voltage.

The vibration exciter 9 can be operated at a certain excitation frequency which differs from the natural frequency of the spreader 1, whereby effective vibration excitation and thus effective removal of deposits on the spread-fan sensor 3 can be achieved. The excitation duration for which the vibration excitation of the spread-fan sensor 3 takes place can be adapted in particular to the degree of contamination. However, the excitation duration is usually only a short period of time.

Alternatively or additionally, the vibration exciter 9 can be configured to excite the one or more spreader fan sensors 3 in such a way that deposits and/or contamination are prevented from the outset or during spreading operation, or at least reduced to a minimum. Furthermore, it may be provided that the one or more spread fan sensors 3 are excited by the vibration exciter 9 before the start of spreading operation and/or at certain, in particular adjustable, intervals and/or time periods during spreading operation.

In order to avoid distortion or interference in the detection of the distribution of the spread material in the spread fan F via the spread fan sensor 3 during the vibration excitation, the detection or evaluation of the distribution of the spread material is temporarily suspended during the vibration excitation. After the vibration has ceased, the detection or evaluation of the spread material distribution via the then cleaned or descaled spread fan sensor 3 is continued.

In addition or as an alternative, the evaluation electronics for evaluating the spread distribution can be configured such that the useful signal of the spread-fan sensor 3 is filtered out of its entire signal spectrum. The bandwidth or spectrum of the excitation frequency is selected such that these are also filtered out of the signal spectrum by the corresponding filters. In this way, interference with the detection or evaluation of the spread material distribution by the spread fan sensor 3 provided with a vibration exciter 9 can be avoided or even prevented.

In addition or as an alternative, the evaluation electronics can be configured such that the algorithm for evaluating the spreading material distribution is adjusted during the vibration exposure. In particular, corresponding filters can be activated only during the vibration exposure and otherwise be deactivated.

As explained above, several spread-fan sensors 3 are usually arranged on a spreader 1, see FIG. 5a. Either each spread-fan sensor 3 can comprise a vibration exciter 9 or only selected spread-fan sensors 3 comprise a vibration exciter 9. For example, vibration exciters 9 can be omitted for spread-fan sensors 3 which, due to their installation space or position, are not exposed to contamination or only to a limited extent.

If each spread-fan sensor 3 is equipped with a vibration exciter 9, these can be excited separately with the respective vibration exciter 9. In particular, the control of the vibration exciters 9 can be configured such that they are only activated when necessary, i.e. when the spread-fan sensor 3 is contaminated. The excitation duration and/or the excitation frequency can also be set separately. Alternatively, all or some of the spread-fan sensors 3 can be excited simultaneously with the respective vibration exciter 9, which reduces the control effort. Furthermore, a configuration is conceivable in which one vibration exciter 9 is responsible for several spread-fan sensors 3 and can excite them sequentially.

Depending on the position of the respective spread-fan sensors 3 relative to the spreading elements 2 and/or the spread fan F, these can be activated for different excitation durations. This allows further adaptation to the respective contamination situation. Spread-fan sensors 3 that become heavily contaminated can be activated for a longer excitation duration.

The method described above for dispensing spreading material, the spreader 1 for dispensing spreading material and the spreader fan sensor 3 are characterised in that the distribution of the spreading material can be reliably detected without the need for time-consuming cleaning, in particular of the sensor surfaces 3.1 of the spreader fan sensors 3. REFERENCE SIGNS
1 Spreader
2 Spreading element
3 Spread-fan sensor
3.1 Sensor surface
4 Environmental sensor
6 Heating means
6.1 Heating wire
7 Housing
8 Tractor
9 Vibration exciter
A Longitudinal axis
B Field of view
D_{H} Heating duration
D_{V} Preheating duration
F Spread fan
I Heating interval
R Direction of travel
t Time
T Temperature
T_{H} Heating temperature
T_{S} Sensor temperature
T_{T} Dew point temperature
T_{V} Preheating temperature
α Detection angle

1. A method for dispensing spreading material with an agricultural spreader comprising at least one spreading element for generating a spread fan and at least one spread-fan sensor for monitoring distribution of the spreading material within the spread fan, comprising:
partially heating the at least one spread-fan sensor by a heating means to ensure that an operation of the at least one spread-fan sensor is independent of contamination or deposits.

2. The method according to claim 1, wherein the at least spread-fan sensor is heated during the spreading of the spreading material for drying a sensor surface with the heating means over a heating period at a heating temperature.

3. The method according to claim 1, wherein the at least one spreader fan sensor is heated with the heating means at a preheating temperature or a preheating period before the spreader is operated in order to dry the sensor surface.

4. The method according to claim 1, wherein the at least one spread-fan sensor is heated with the heating means in such a way that a sensor temperature is always above a dew point temperature.

5. The method according to claim 4, wherein the dew point temperature is determined from one or more environmental parameters.

6. The method according to claim 5, wherein the environmental parameters are detected by an environmental sensor arranged in particular on the spreader and/or originate from an external data source.

7. The method according to claim 4, wherein the sensor temperature is determined based on one or more environmental parameters.

8. The method according to claim 1, wherein the at least one spread-fan sensor is at least partially supplied with compressed air for cleaning the sensor surface by means of a compressed air supply.

9. The method according to claim 8, wherein during the spreading of the spreading material, compressed air is supplied for cleaning the sensor surface via the compressed air supply for a ventilation period.

10. The method according to claim 1, further comprising additional spread-fan sensors which are heated separately by the heating means at least partially and/or supplied with compressed air at least partially by the compressed air supply.

11. An agricultural spreader for dispensing spreading material, with at least one spreading element for generating a spread fan and at least one spread-fan sensor for monitoring the distribution of the spreading material within the spread fan, comprising
a heating means for at least partially heating the at least one spread-fan sensor to ensure an operation of the sensor independent of contamination and/or deposits.

12. A spread-fan sensor for monitoring the distribution of spreading material in a spread fan generated by a spreader for distributing spreading material on a usable area,
comprising
a heating means for at least partially heating the spread-fan sensor to ensure an operation of the sensor independent of contamination and/or deposits.
